(19) United States
(12) Patent Application Publication
(10) Pub. No.: US 2022/0011588 A1
(43) Pub. Date: Jan. 13, 2022

(54) DISPLAY BOARD AND DISPLAY DEVICE

(71) Applicant: KABUSHIKI KAISHA TOKAI RIKA DENKI SEISAKUSHO, Aichi (JP)

(72) Inventor: Atsushi YAMAGUCHI, Aichi (JP)

(73) Assignee: KABUSHIKI KAISHA TOKAI RIKA DENKI SEISAKUSHO, Aichi (JP)

(21) Appl. No.: 17/295,509

(22) PCT Filed: Jul. 10, 2019
(86) PCT No.: PCT/JP2019/027299

§ 371 Date: May 20, 2021

(30) Foreign Application Priority Data
Nov. 26, 2018 (JP) 2018-220381
Feb. 6, 2019 (JP) 2019-019563

(51) Int. Cl. G02B 27/28; G02B 5/00

(52) U.S. Cl. CPC G02B 27/288; G02B 5/003

(57) ABSTRACT

[Object] To switch display while reducing a difference in luminance between regions more.

[Solution] Provided is a display board including: a first region that includes a metal film that is striped in a first direction; a second region that includes the metal film that is striped in a second direction, which is perpendicular to the first direction; a composite region that partially includes the metal film and transmits two types of illumination light, which have different polarization directions, at comparable rates; and a light shielding region that has a surface entirely covered with the metal film. In addition, provided is a display device including: the display board; and a light source that emits the two types of illumination light, which have different polarization directions, toward the display board.

### TECHNICAL FIELD

The present invention relates to a display board and a display device.

### BACKGROUND ART

There have been known technologies of switchably displaying different graphics or the like on a same display surface without using a complicated structure such as a display. For example, Patent Literature 1 discloses a display device that switches display using one display board by means of polarization. This display device makes it possible to switchably display two graphics or the like by using a simple structure. The two graphics have display regions that partially overlap each other.

### CITATION LIST

### Patent Literature

Patent Literature 1: JP 2017-194582A

### DISCLOSURE OF INVENTION

### Technical Problem

Here, for example, in the case of controlling switching of display by using two types of illumination light having different polarization directions as described in Patent Literature 1, it is important to consider a difference in luminance between a region that transmits one of the two types of illumination light and a region that transmits the both types of illumination light.

Accordingly, the present invention is made in view of the aforementioned issues, and an object of the present invention is to provide a novel and improved display board and display device that make it possible to switch display while reducing a difference in luminance between regions more.

### Solution to Problem

To solve the above-described problems, according to an aspect of the present invention, there is provided a display board including: a first region that includes a metal film that is striped in a first direction; a second region that includes the metal film that is striped in a second direction, which is perpendicular to the first direction; a composite region that partially includes the metal film and transmits two types of illumination light, which have different polarization directions, at comparable rates; and a light shielding region that has a surface entirely covered with the metal film

In addition, the composite region may include the metal film that is striped in a third direction, which is different from the first direction and the second direction.

In addition, the third direction may be a direction substantially intermediate between the first direction and the second direction.

In addition, the composite region may include a first small region and a second small region, which have comparable areas, the first small region including the metal film that is striped in the first direction, the second small region including the metal film that is striped in the second direction.

In addition, the first small region and the second small region may form a fine lattice-like structure.

In addition, to solve the above-described problems, according to another aspect of the present invention, there is provided a display device including: a display board including a first region that includes a metal film that is striped in a first direction, a second region that includes the metal film that is striped in a second direction, which is perpendicular to the first direction, a composite region that partially includes the metal film and transmits two types of illumination light, which have different polarization directions, at comparable rates, and a light shielding region that has a surface entirely covered with the metal film; and a light source that emits the two types of illumination light, which have different polarization directions, toward the display board.

### Advantageous Effects of Invention

As described above, according to the present invention, it is possible to switch display while reducing a difference in luminance between regions more.

### BRIEF DESCRIPTION OF DRAWINGS

FIG. 1 is a diagram illustrating an example of a metal film formation pattern in a composite region according to an embodiment of the present invention.

FIG. 2 is a diagram illustrating an example of the metal film formation pattern in the composite region according to the embodiment.

FIG. 3 is a diagram illustrating a flow of processing performed in the case of forming a metal film and then removing a predetermined portion of the metal film according to the embodiment.

FIG. 4 is a diagram illustrating a flow of processing performed in the case of transferring a structure and then forming a metal film according to the embodiment.

FIG. 5 is a diagram illustrating a configuration example of a display device according to the embodiment.

FIG. 6 is a diagram simply illustrating a configuration of a conventional display board that makes it possible to switch display by means of polarization.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

### 1. Embodiment

As described above, there have been known technologies of switchably displaying different graphics or the like on a same display surface without using a complicated structure such as a display. For example, Patent Literature 1 discloses the display device that switches display using one display board by means of polarization.

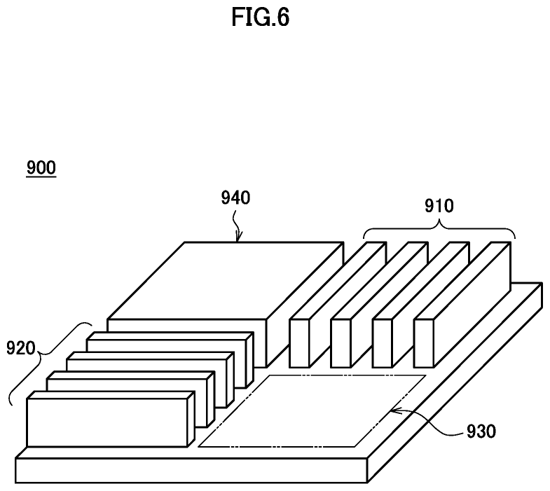

FIG. 6 is a diagram simply illustrating a configuration of a conventional display board that makes it possible to switch display by means of polarization. As illustrated in FIG. 6, for example, a conventional display board 900 includes a first region 910, a second region 920, a composite region 930, and a light shielding region 940.

The first region 910 is a region including a metal film that is striped in a first direction (such as a vertical direction). When the metal film is formed as described above, it is possible to absorb illumination light whose polarization direction is the first direction, and transmit only illumination light whose polarization direction is a second direction (such as a horizontal direction), which is perpendicular to the first direction.

In addition, the second region 920 is a region including a metal film that is striped in the second direction. In contradiction to the first region 910, when the metal film is formed as described above, it is possible to absorb only illumination light whose polarization direction is the second direction, and transmit only illumination light whose polarization direction is the first direction.

In addition, the composite region 930 is a region including no metal film Therefore, the composite region 930 transmits both the illumination light whose polarization direction is the first direction and the illumination light whose polarization direction is the second direction.

In addition, the light shielding region 940 is a region covered with a metal film. In other words, the light shielding region 940 absorbs both the illumination light whose polarization direction is the first direction and the illumination light whose polarization direction is the second direction.

As described above, the conventional display board 900 achieves switchable display of two different graphics or the like by including the four regions, which have different characteristics related to absorption and transmission of two types of illumination light having different polarization directions.

Specifically, in the case where the display board 900 is irradiated with illumination light whose polarization direction is the first direction, the illumination light passes through the second region 920 and the composite region 930 and a first graphic is displayed. On the other hand, in the case where the display board 900 is irradiated with illumination light whose polarization direction is the second direction, the illumination light passes through the first region 910 and the composite region 930 and a second graphic is displayed.

As described above, the conventional display board 900 makes it possible to switchably display the two graphics or the like by using the simple structure. The two graphics have display regions that partially overlap each other. Therefore, for example, when the conventional display board 900 is applied to various kinds of switches installed in vehicles, it is possible to redouble display of graphics or the like related to switches, and allocate two functions to a single switch.

On the other hand, for example, in the case of taking no measure with regard to the structure illustrated in FIG. 6, there may be a difference in luminance between a region that transmits one of the two types of illumination light and a region that transmits the both types of illumination light. Specifically, the composite region 930 that transmits the both types of illumination light has high luminance because the composite region 930 includes no metal film, and the first region 910 and the second region 920, each of which transmits one of the two types of illumination light, has low luminance because the first region 910 and the second region 920 include metal films

The technical idea of the present invention was conceived by focusing on the above-described points, and makes it possible to achieve switchable display while reducing a difference in luminance between regions. Therefore, a display board 100 according to an embodiment of the present disclosure includes: a first region 110 that includes a metal film that is striped in a first direction; a second region 120 that includes the metal film that is striped in a second direction, which is perpendicular to the first direction; a composite region 130 that partially includes the metal film and transmits two types of illumination light, which have different polarization directions, at comparable rates; and a light shielding region 140 that has a surface entirely covered with the metal film

In other words, unlike the composite region 930 of the conventional display board 900, the composite region 130 of the display board 100 according to the present embodiment partially includes the metal film. This feature makes it possible to reduce the transmittance of illumination light through the composite region and reduce a difference in luminance between the first region 110 and the second region 120.

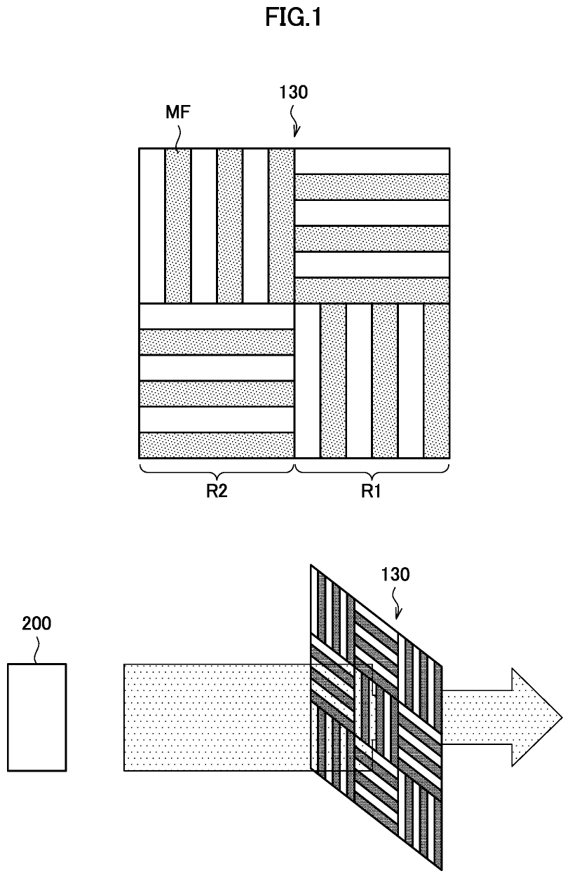

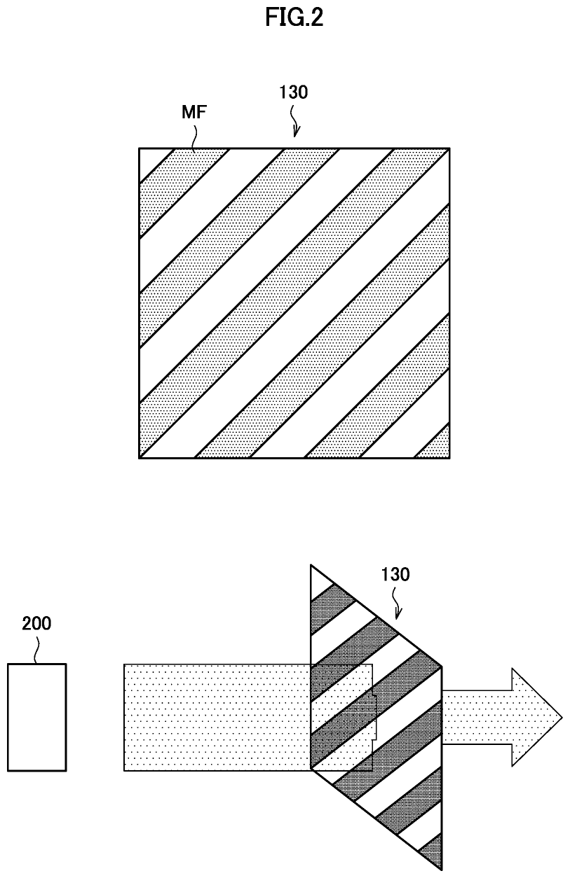

Here, to obtain the above-described effects, it is necessary to form the metal films in such a manner that the composite region 130 transmits two types of illumination light, which have different polarization directions, at comparable rates. Accordingly, for example, the composite region 130 according to the present embodiment may have a metal film formation pattern as illustrated in FIG. 1 or FIG. 2. FIG. 1 and FIG. 2 are diagrams illustrating examples of a metal film formation pattern in the composite region 130 according to the present embodiment.

For example, in the case of the example illustrated in the left side of FIG. 1, the composite region 130 according to the present embodiment includes a first small region R1 and a second small region R2, which have comparable areas, the first small region R1 including a metal film MF that is striped in the first direction, the second small region R2 including the metal film that is striped in the second direction.

In other words, the composite region 130 according to the present embodiment includes a combination of a small region including a metal film having a pattern similar to the first region 110 that transmits only illumination light whose polarization direction is the second direction, and a small region including a metal film having a pattern similar to the second region 120 that transmits only illumination light whose polarization direction is the first direction.

The composite region 130 having the above-described structure makes it possible to transmit two types of illumination light, which have different polarization directions, at comparable rates. In addition, as illustrated in the right side of FIG. 1, it is possible to reduce a difference in luminance between the first region 110 and the second region 120 by suppressing the transmittance of illumination light emitted from a light source 200, to a target value.

Note that, the first small regions and the second small regions according to the present embodiment may form a fine lattice-like structure. Such a configuration makes it possible to deter variation in difference in luminance in the composite region 130, and achieve display without a feeling of strangeness.

In addition, for example, in the case of the example illustrated in FIG. 2, the composite region 130 according to the present embodiment includes the metal film MF that is striped in a third direction, which is different from the first direction and the second direction as illustrated in the left side of FIG. 2. More specifically, the third direction may be a direction substantially intermediate between the first direction and the second direction. For example, in the case where the first direction is a 0-degree direction and the second direction is a 90-degree direction, the third direction according to the present embodiment is approximately 45 degrees.

The composite region 130 having the above-described structure makes it possible to reduce the transmittance of illumination light that is emitted from the light source 200 and whose polarization direction is the first direction or the second direction, to roughly half as illustrated in the right side of FIG. 2. In addition, it is possible to reduce a difference in luminance between the first region 110 and the second region 120.

The structural example of the composite region 130 according to the present embodiment has been described above. Note that, the metal film formation patterns of the composite region 130 illustrated in FIG. 1 and FIG. 2 are adjusted in such a manner that the transmittance of illumination light through the composite region 130 is similar to the transmittance of illumination light through the first region 110 and the second region 120.

For example, the transmittance can be adjusted as described above by changing a stripe interval, width, shape, or the like. In addition, the transmittance can also be adjusted by adjusting the metal film formation patterns of the first region 110 and the second region 120.

The above-described adjustment makes it possible to reduce the transmittance of the illumination light through the composite region 130 to the target value. Therefore, it is possible to effectively reduce a difference in luminance between the first region 110 and the second region. This makes it possible to display every portions of graphics or the like with approximately uniform luminance, and it is possible to achieve display with a less feeling of strangeness.

Next, a method of manufacturing the display board 100 according to the present embodiment will be described. Examples of the method of manufacturing the display board 100 according to the present embodiment include a method of forming the metal film and then removing a predetermined portion of the metal film through etching or the like, and a method of transferring a structure and then forming the metal film through vapor deposition or the like.

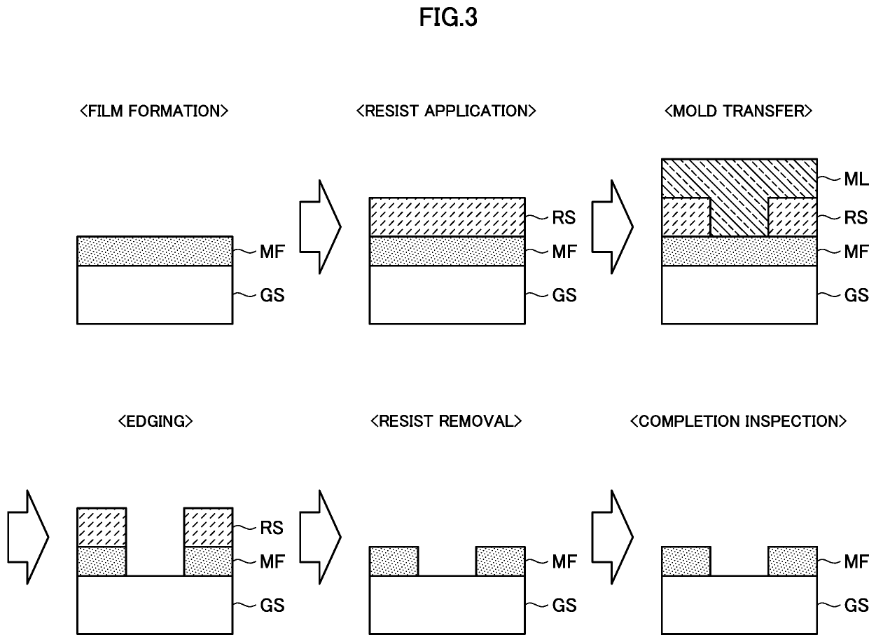

FIG. 3 is a diagram illustrating a flow of processing performed in the case of forming the metal film and then removing a predetermined portion of the metal film. In this case, as illustrated in the upper left side of FIG. 3, a metal film MF is formed first on a glass substrate GS by using a film formation device. Note that, for example, material such as aluminum or chromium may be used for the metal film MF.

Next, a resist RS is applied to the formed metal film MF by using a die coater. Resin material is used for the resist RS. In addition, after the application of the resist RS, mold transfer is performed by a nanoimprint device using a mold ML.

Next, etching is performed by a dry etching device to fit a transferred shape of the mold ML, and then the resist RS is removed by a dry cleaning device. Next, a completion inspection is performed by using an image processing device, and a completed display board 100 is obtained.

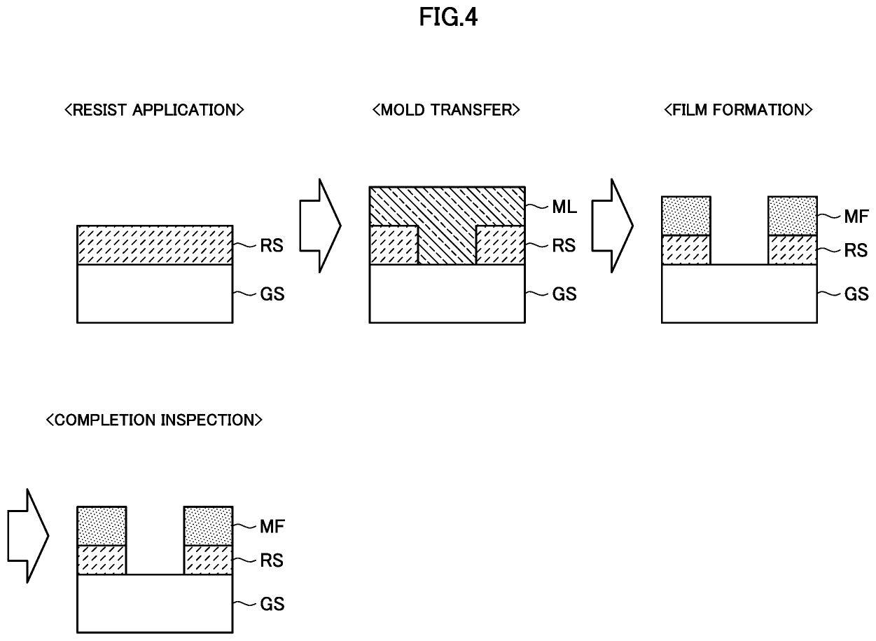

The flow of processing for forming the metal film and then removing a predetermined portion of the metal film has been described above. Next, the method of transferring the structure and then forming the metal film will be described. FIG. 4 is a diagram illustrating a flow of processing performed in the case of transferring a structure and then forming the metal film

In this case, as illustrated in the upper left side of FIG. 4, the resist RS is first applied to the glass substrate GS by using the die coater. Next, the mold transfer is performed by the nanoimprint device using the mold ML.

Next, the metal film MF is formed through vapor deposition performed by a sputtering device, the completion inspection is performed by using the image processing device, and a completed display board 100 is obtained.

The flow of processing according to the method of transferring the structure and then forming the metal film has been described above. By using this method, the metal film is preferentially attached to a tip of a protrusion structure, and the metal film is less likely to be attached to a bottom, on which the protrusion structure is not formed. Therefore, for example, it is not necessary to perform a process of covering the bottom with a film formation mask or the like during the vapor deposition, and it is possible to effectively manufacture the display board 100.

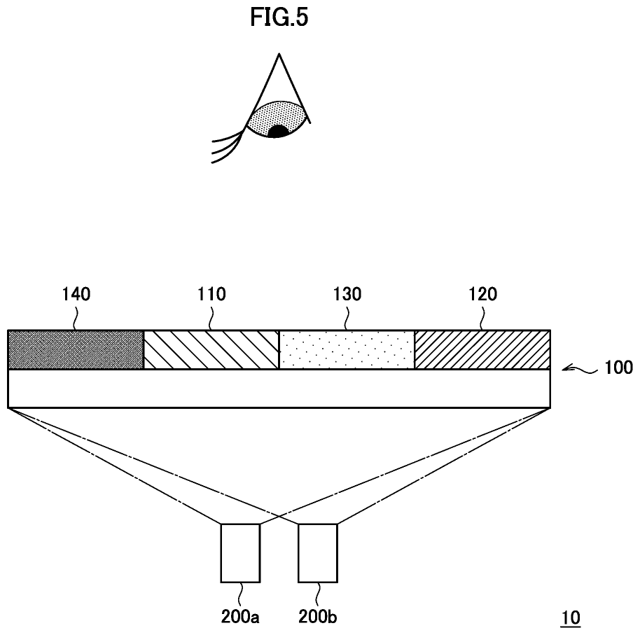

Next, a configuration example of a display device 10 according to the present embodiment will be described. FIG. 5 is a diagram illustrating the configuration example of the display device 10 according to the present embodiment. As illustrated in FIG. 5, the display device 10 according to the present embodiment includes the above described display board 100 and light sources 200a and 200b, which emits illumination light toward the display board 100.

In addition, as illustrated in FIG. 5, the display board 100 according to the present embodiment includes the first region 110, the second region 120, the composite region 130, and the light shielding region 140.

In addition, the light source 200a according to the present embodiment emits illumination light whose polarization direction is the first direction, and the light source 200b according to the present embodiment emits illumination light whose polarization direction is the second direction. For example, the light sources 200a and 200b according to the present embodiment may emit laser light or LED light.

For example, in the case of the laser light, the light sources 200a and 200b adjust the polarization directions in such a manner that each laser light includes a polarization component in a predetermined direction. In addition, for example, in the case of the LED light, polarizers are disposed near illumination sections of the light sources 200a and 200b in such a manner that each LED light includes a polarization component in a predetermined direction. As described above, the display device 10 according to the present embodiment may use the two light sources to emit two illumination light beam having different polarization directions toward the display board 100 and switchably display graphics or the like, which are different from each other.

The configuration example of the display device 10 according to the present embodiment has been described above. Note that, the configuration described above with reference to FIG. 5 is a mere example. The configuration of the display device 10 according to the present embodiment is not limited thereto. For example, the case where the display device 10 includes the two independent light sources 200a and 200b has been described above. However, it is also possible for the display device 10 according to the present embodiment to use a single light source 200 to emit two types of illumination light having different polarization directions.

For example, in the case where the light source 200 emits the LED light, a polarizer such as a polarizing plate may be disposed near the illumination section of the light source 200. The polarizing plate is rotatable in a direction coaxial with an illumination axis. In this case, the polarizer may rotate 90 degrees between a first rotational position and a second rotational position. At the first rotational position, the polarizer transmits light whose polarization direction is the first direction. At the second rotational position, the polarizer transmits light whose polarization direction is the second direction. Such a configuration makes it possible to emit the two types of illumination light, which have different polarization directions, toward the display board 100.

In addition, for example, in the case where the light source 200 can emit light whose polarization direction can be previously set such as the laser light, the light source 200 itself may rotate in a direction coaxial with the illumination axis. In other words, it is possible for the light source 200 to emit two types of illumination light, which have different polarization directions, toward the display board 100 by rotating 90 degrees between a first rotational position and a second rotational position. At the first rotational position, the light source 200 emits light whose polarization direction is the first direction. At the second rotational position, the light source 200 emits light whose polarization direction is the second direction. As described above, the configuration of the display device 10 according to the present embodiment can be flexibly modified in accordance with specifications and operations.

### 2. Conclusion

As described above, the display board 100 according to an embodiment of the present disclosure includes: the first region 110 that includes the metal film that is striped in the first direction; the second region 120 that includes the metal film that is striped in the second direction, which is perpendicular to the first direction; the composite region 130 that partially includes the metal film and transmits two types of illumination light, which have different polarization directions, at comparable rates; and the light shielding region 140 that has the surface entirely covered with the metal film. Such a configuration makes it possible to switch display while reducing a difference in luminance between the regions more.

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

In addition, the effects described herein are illustrative or exemplary but not limitative. That is, besides the above effects or instead of the above effects, the technology according to the present disclosure may provide other effects that are obvious to a person skilled in the art.

### REFERENCE SIGNS LIST

10 display device
100 display board
110 first region
120 second region
130 composite region
140 light shielding region
200a, 200b light source

1. A display board comprising:
a first region that includes a metal film that is striped in a first direction;
a second region that includes the metal film that is striped in a second direction, which is perpendicular to the first direction;
a composite region that partially includes the metal film and transmits two types of illumination light, which have different polarization directions, at comparable rates; and
a light shielding region that has a surface entirely covered with the metal film.

2. The display board according to claim 1,
wherein the composite region includes the metal film that is striped in a third direction, which is different from the first direction and the second direction.

3. The display board according to claim 2,
wherein the third direction is a direction substantially intermediate between the first direction and the second direction.

4. The display board according to claim 1,
wherein, the composite region includes a first small region and a second small region, which have comparable areas, the first small region including the metal film that is striped in the first direction, the second small region including the metal film that is striped in the second direction.

5. The display board according to claim 4,
wherein the first small region and the second small region form a fine lattice-like structure.

6. A display device comprising:
a display board including
a first region that includes a metal film that is striped in a first direction,
a second region that includes the metal film that is striped in a second direction, which is perpendicular to the first direction,
a composite region that partially includes the metal film and transmits two types of illumination light, which have different polarization directions, at comparable rates, and
a light shielding region that has a surface entirely covered with the metal film; and
a light source that emits the two types of illumination light, which have different polarization directions, toward the display board.
